(19) United States
(12) Patent Application Publication
(10) Pub. No.: US 2022/0224280 A1
(43) Pub. Date: Jul. 14, 2022

(54) Rail and Splice Foot Mounting System for Photovoltaic Panels

(71) Applicant: K2 Systems, LLC, Vista, CA (US)

(72) Inventors: Tyler Wiggins, Vista, CA (US); Andrew Neshat, San Diego, CA (US); Matthew Danning, Oakland, CA (US); Veit Schutz, Stuttgart (DE)

(21) Appl. No.: 17/572,929

(22) Filed: Jan. 11, 2022

Related U.S. Application Data
(60) Provisional application No. 63/135,968, filed on Jan. 11, 2021.

(51) Int. Cl. H02S 20/25; H02S 20/30

(52) U.S. Cl. CPC H02S 20/25; H02S 20/30

(57) ABSTRACT

A PV array rail mounting system for use on support structures. In an aspect, the PV array rail mounting system includes rails and splice foot connectors. In an aspect, the splice foot connectors can support one or two rails, eliminating the need of a splice.

### CROSS-REFERENCE TO RELATED APPLICATIONS

The present application claims priority from Provisional Patent Application No. 63/135,968, filed on Jan. 11, 2021, the disclosure of which is relied upon and incorporated herein by reference.

### FIELD OF INVENTION

This invention generally relates to photovoltaic arrays, and more particularly to a rail system for mounting of photovoltaic (PV) arrays and associated hardware.

### BACKGROUND OF THE INVENTION

A photovoltaic (PV) installation typically includes a collection of photovoltaic modules combined and secured to a support structure that combines each of the photovoltaic components to form a photovoltaic array. Typically, photovoltaic arrays are placed in an outdoor location, commonly rooftops, so that the photovoltaic arrays are exposed to sunlight in order to produce electricity. In most residential settings, the rooftops are sloped roofs.

Standard dual rail systems, standard shared rail systems, and standard rail-less systems have been used in various roof installations, ground mount installations, façade installations or installations on floats. However, all three systems have their drawbacks. For example, standard dual and shared rail systems utilize rails of a long length, typically between sixteen (16) to twenty feet (20) each. Rails of such lengths are expensive to ship and cumbersome to manipulate on the roof. In addition, the rails must be cut to length during installations (to fit the roof or the span of PV panels), which can lead to inaccurate cuts or wasted offcuts which cannot be used and are discarded. Further, the aforementioned rail-based systems utilize separate L-feet and splice sections. FIG. 1 shows a typical standard rail installation with all needed components (rails, L-feet, splices, and PV modules). As shown, the L-feet (labeled as “Roof Attachments” in FIG. 1) are mounted at various rafters of the roof, with splice sections connecting the different portions of rail. Note the large quantities of parts and need for splices and L-feet, leading to a high part count and complicated installation. FIG. 2 illustrates an installed shared rail system, having fewer rails, L-feet (labeled as “Roof Attachments”), and splices than a standard dual rail system as shown in FIG. 1. However, the installation still requires a good number of extra parts, including splices, and still utilizes long rails that must be cut to fit the roof.

While rail-less systems eliminate the cumbersome nature of rails, have their own shortcomings as well. FIGS. 3-5 illustrate typical rail-less attachment components that provide adjustability in height and north/south placement. While the adjustability of such a component may be seen as a benefit, several problems may arise because the sheer number of adjustable components that are installed, leading to the need to adjust each and every one of the components. In addition, splices, as shown in FIG. 5, are still needed to join PV modules to form a stiff and rigid structure much like the function of a rail. FIG. 6 illustrates a typical rail-less system installation, showing rafter locations and the interactions of the attachments and splices. Not only is the layout complicated, but as mentioned above, the individual adjustment of the components and PV modules can be very complicated as well.

Therefore, there is a need for a PV mounting system that eliminates the drawbacks of traditional dual and shared rail systems while avoided the complexity found in rail-less PV mounting systems.

### SUMMARY OF THE INVENTION

A PV array short rail and splice foot mounting system for use on support structures such as roofs. In an aspect, the PV array short rail mounting system includes short rails and L-foot connectors. In an aspect, the rails are the length of a span. In another aspect, the mounting system includes splice foot mounts that allow one or two rails to be mounted in a continuous line without the need for a separate splice.

In an aspect, the invention is directed to a photovoltaic array rail mounting system for use on a roof that includes at least one rail and a splice foot connector that can support one rail or two rails. In such aspects, the splice foot connector serves as both a mounting bracket and a splice. The splice foot connector can be configured to receive span-length rails to support a photovoltaic array. In an aspect, the splice foot connector can include a roof mount component and a rail mount component forming a substantially 90-degree angle with one another. In an aspect, the splice foot connector can be configured to be mounted on a tile replacement.

In an aspect, the rail mount component can include a plurality of apertures that allow connection to one rail or two rails. In such aspects, the plurality of apertures can include elongated apertures to allow for adjustable rail mounting. In other aspects, the roof mount component includes a raised base member to provide horizontal support for the at least one rail.

In an aspect, the photovoltaic array rail mounting system can include a cover configured to fit over the one splice foot connector. The photovoltaic array rail mounting system can also include a butyl pad to be placed between the roof mount component and the roof. The photovoltaic array rail mounting system can include a standing seam clamp used to mount the splice foot connector to a standing seam roof.

In an aspect, the invention is directed at a method of mounting a photovoltaic ray on a surface that includes mounting a splice foot connector, configured to support one or two rails, onto the surface, mounting the one or two rail onto the splice foot connector using one or more fasteners, and mounting the photovoltaic ray to the one or the two rails. In such methods, the slice foot connector can include a roof mount component and a rail mount component that form a substantially 90-degree angle with one another, with the roof mount component mounted to the surface and the one or two rails mounted to the rail mount component, the rail mount component including a first aperture and a second aperture. In methods in which two rails are mounted, the rails are mounted to the roof mount component by securing a first rail to the first aperture and securing a second rail to the second aperture. In other aspects, the roof mount component includes a base member configured to support the one or two rails.

These and other objects and advantages of the invention will become apparent from the following detailed description of the preferred embodiment of the invention. Both the foregoing general description and the following detailed description are exemplary and explanatory only and are intended to provide further explanation of the invention as claimed.

The accompanying drawings are included to provide a further understanding of the invention and are incorporated in and constitute part of this specification, as well as illustrate several embodiments of the invention that together with the description serve to explain the principles of the invention.

### BRIEF DESCRIPTION OF THE FIGURES

FIG. 1 is a schematic representation of a photovoltaic (PV) array installation on a roof using a dual rail mounting system known in the prior art.

FIG. 2 is a schematic representation of PV array installation on a roof using a shared rail mounting system known in the prior art.

FIGS. 3-5 illustrate components of a rail-less PV mounting system known in the prior art.

FIG. 6 is a schematic representation of PV array installation on a roof utilizing the rail-less mounting system components of FIGS. 3-5.

FIGS. 7-8 are perspective elevated views of components of a short rail mounting system according to aspects of the current invention.

FIGS. 9-10 are schematic representations of PV array installation on a roof utilizing the short-rail mounting system according to an aspect of the present invention.

FIG. 11 is a perspective elevated view of components of a short rail mounting system according to an aspect of the current invention.

FIG. 12 is a schematic representation of a PV array installation on a roof utilizing components of the short-rail mounting system shown in FIG. 11.

FIGS. 13-14 are perspective elevated views of components of a short rail mounting system according to aspects of the current invention.

FIG. 15 is a schematic representation of a PV array installation on a roof utilizing components of the short-rail mounting system shown in FIGS. 13-14.

FIG. 16 is a schematic representation of a PV array installation on a roof utilizing components of the short-rail mounting system shown in FIGS. 7-8 and 11.

FIGS. 17-24 illustrate an embodiment of the splice foot connector according to an aspect of the present invention.

FIGS. 25-27 illustrate an embodiment of the splice foot connector according to an aspect of the present invention.

FIGS. 28-28A illustrate a rail and splice foot connector assembly according to an aspect of the present invention.

FIG. 29 illustrates an exploded view of a splice foot connector and rail assembly according to an aspect of the present invention.

FIGS. 30-32 illustrate a cover and splice foot connector assembly according to an aspect of the present invention.

FIGS. 33-39 illustrate a splice foot connector mounted to various roofing and support structures according to embodiments of the present invention.

FIG. 40 illustrate an embodiment of the splice foot XL connector according to an aspect of the present invention.

FIG. 41 illustrates a rail and splice foot XL connector assembly according to an aspect of the present invention.

FIGS. 42A-42B illustrate potential rail and splice foot connector assemblies according to an aspect of the present invention.

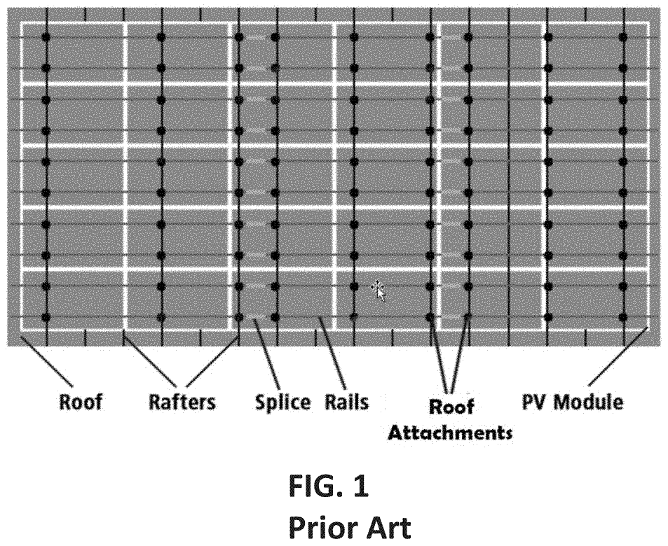

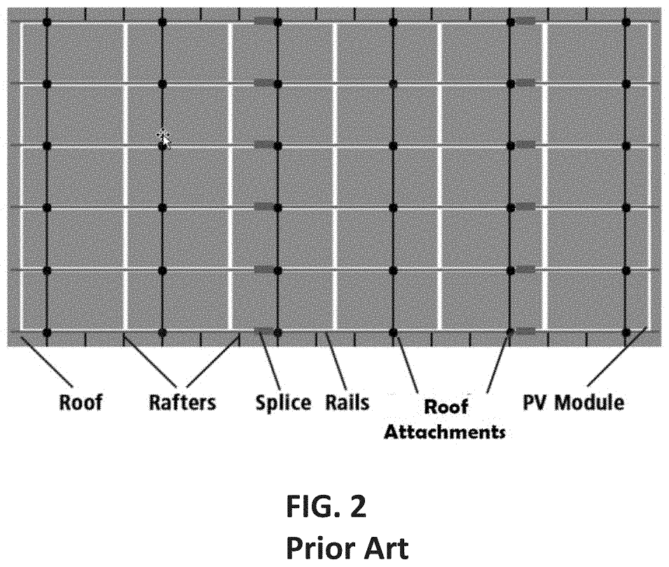

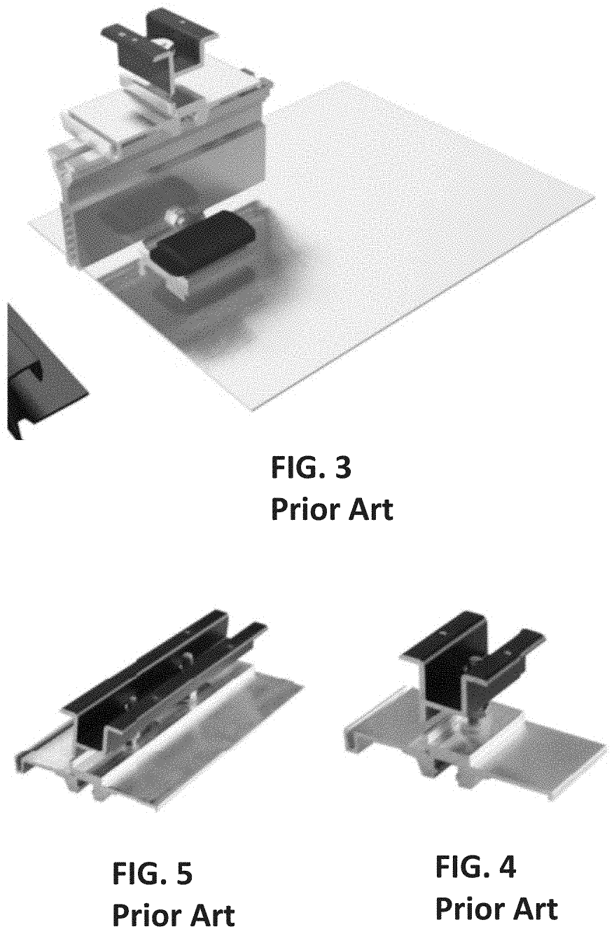

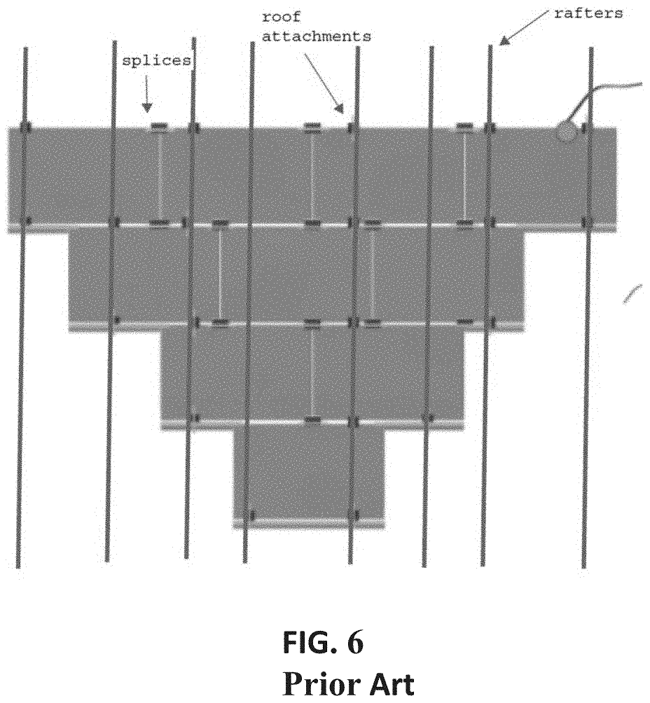

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the following description, numerous specific details are set forth. However, it is to be understood that embodiments of the invention may be practiced without these specific details. In other instances, well-known methods, structures, and techniques have been shown in detail in order not to obscure an understanding of this description.

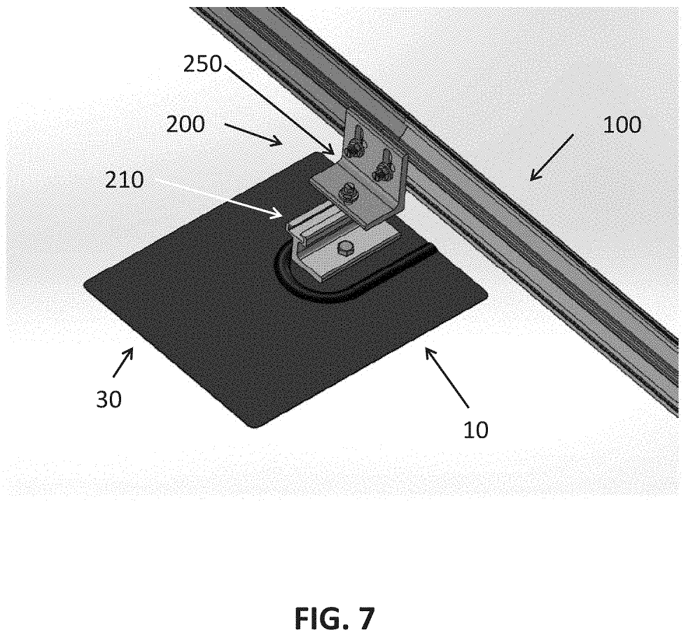

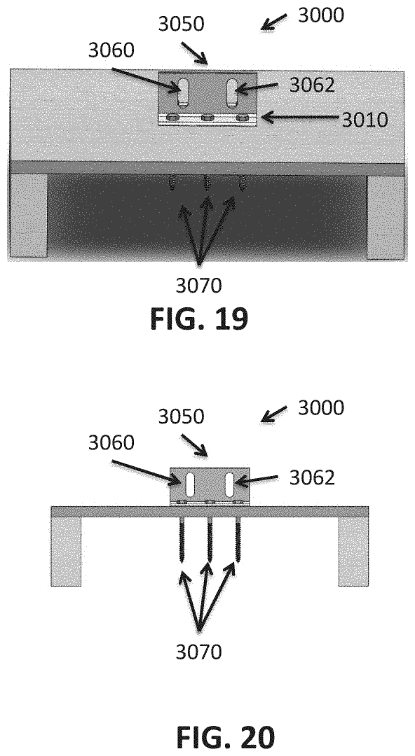

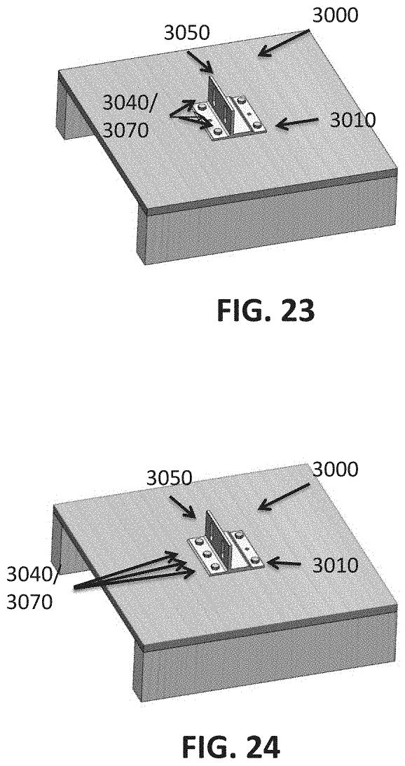

In an aspect, one embodiment of the present invention, as shown in FIGS. 7-16, is directed towards a short rail photovoltaic (PV) array rail mounting system (SPARM) 10. In an aspect, as illustrated in FIGS. 7-16, the SPARM system 10 includes a short rail 100 and an L-foot connector 200 used to provide support and a place to mount solar components 300. The solar components 300 can include, but are not limited to, PV panels, racking components, wind deflectors, ballast pans, micro-inventers, optimizers, wire management solutions, and the like commonly used in solar panel mounting systems. The SPARM system 10 is configured to allow solar components 300 (e.g., PV panels) to be mounted on roofs. In an aspect, the SPARM system 10 is configured to be used on residential sloped roofs which have rafters 25 spaced at regular intervals. However, the SPARM system 10 can be utilized in other settings that have regularly spaced support portions similar to structural rafters. In an aspect, the SPARM system 10 can include multiple short rails 100 and L-foot connectors 200, 1200, 2200, and 3000 as shown in FIGS. 7-10, 11-12, 13-16, and 17-24 respectively.

In an aspect, the rails 100 and the L-foot connectors 200 can be formed from materials that can withstand exposure to environmental elements while meeting the standards of the solar panel industry. Such standards include, but are not limited to, UL 2703 and UL 1703. For example, the short rail 100 and L-foot connectors 200 can be made from, but not limited to, metallic materials (e.g., aluminum, stainless steel, and the like), polymer materials (e.g., plastics and the like), and other materials. In an exemplary aspect, the short rails 100 and L-foot connector 200 are made from aluminums including, but not limited to, AL 6061-T6, 6063-T66, 6005A-T5, 6006A-T61, 6082A-T6 or the equivalent. However, in an aspect, the short rail 100 can include a coating or an anodization.

In an aspect, the short rails 100 of the SPARM 10 are configured to have the same characteristics of regular rails, shared and dual, used in PV mounting systems, but without having the same traditional length found in rails (e.g., anywhere between 14 to 20 feet in length). In an aspect, the short rails 100 have a length 110 (See FIG. 10) that is equal to the span-length. In an aspect, span is the distance between attachments to the roof, which is dictated in part by the distance between rafters. The span can be dictated based upon requirements of the SPARM 10 and the spacing between rafters 25. For example, when the SPARM 10 is going to be in high wind or snow areas, the span is required to be shorter. Likewise, while rafters 25 are typically installed 2 feet apart, in some areas in heavy snow regions, the rafters 25 can be spaced sixteen inches apart from one another. Therefore, the span in California can be 6 feet, whereas in Utah the span can be 4 feet.

In an aspect, the span-length can equal six (6) feet, which translate to a length 110 of six (6) feet for the short rails 100 of the SPARM 10. However, the span length can vary from roof to roof, as discussed above, so the length 110 of the short rails 100 corresponds to the span for various installations, depending on wind loads, snow loads, roof height, and the like. The span lengths will also match up with rafters 25 of the roof (i.e., the span extends over a repeatable number of rafters 25, allowing the L-foot connectors 200 a secured mounting location). In an aspect, the rails 100 can include various apertures (not shown) that are used to receive fastening devices to be connected to the L-foot connectors 200. In an aspect, the short rails 100 allow the SPARM 10 to be set up as a dual rail system or a shared rail system.

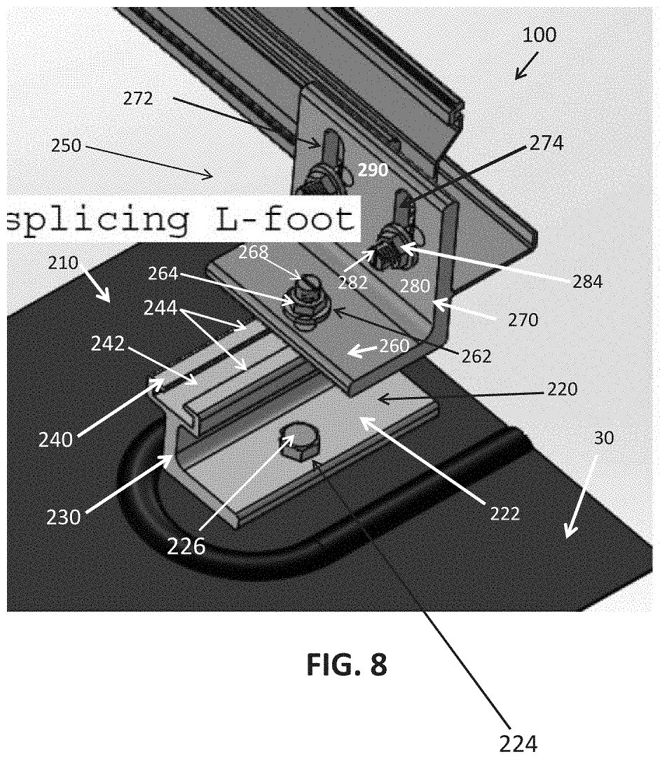

The L-foot connectors 200 of the SPARM 10 are used to mount the short rails 100 to one another as well as to the roof 20. In an aspect, the L-foot connectors 200 can take the form of a splice foot connector 200 (FIGS. 7-8) that splices (i.e., connect) the short rails 100 to one another as well. In an aspect, the L-foot connectors 200 include a roof mount component 210 and a rail mount component 250, as shown in FIGS. 7-8. The roof mount component 210 of the splice foot connector 200 can take various forms in other embodiments of splice foot mounts 200, as discussed below. In all aspects, the roof mount component 210 is configured to mount the spice foot connector 200 to the roof or support surface on which the rails are to be mounted. Similarly, the rail mount component 250 of the splice foot connector 200 can take various forms, but will provide a component on which to mount one or two rails together, as discussed in more detail below.

In an aspect, the roof mount component 210 includes a base portion 220 that is connected to a vertical portion 230. The base portion 220 can include a flange 222 with at least one aperture 224 configured to receive a fastener 226. The fastener 226 can be inserted into the aperture 224 to secure the L-foot connector 200 to the roof at a rafter/joist 25. In an aspect, flashing 30 can be placed between the L-foot connectors 200 and the roof. By placing the L-foot connector 200 at a rafter 25, it does not need to be structural, since the rafter 25 is directly underneath to provide support.

In an aspect, the base portion 220 and a vertical portion 230 are connected to one another to form the L-foot shape, with the two components 220, 230 forming a right angle. In an aspect, the vertical portion 230 can include a T-portion 240. The T-portion 240 can include a channel 242 that includes flanges 244 extending over the channel 242. The combination of the flanges 244 and the channel 242 can adjustably retain a fastener used to attach the rail mount component 250.

In an aspect, the rail mount component 250 includes a horizontal portion 260 and a vertical portion 270 that meet to form an L-shape. In, an aspect, the horizontal portion 260 includes at least one aperture 262 configured to receive a fastener 264 which is used to adjustably secure the rail mount component 250 to the T-portion 240 of the roof mount component 210 of the L-foot mount 200. The fastener 264 can include a nut 266 and a bolt 268, with the head of the bolt 268 configured to be adjustably received within the channel 242 of the T-portion 240 of the roof mount 210, with the flanges 244 retaining the head of the bolt 268 in the channel 242.

In an aspect, the vertical portion 270 of the rail mount component 250 includes two apertures 272, 274. In an aspect, the apertures 272, 274 are configured to receive fasteners 280 to connect ends of different short rails 100 to the rail mount component 250. In an aspect, the apertures 272, 274 can be configured to allow the fasteners 280, and the rail 100, to be adjusted in a vertical direction. Similar to the fastener 264 connecting the T-portion 240 of the roof mount component 210 to the horizontal portion 260 of the rail mount component 250, the fasteners 280 can include a combination of bolts 282 and nuts 284. In addition, washers can be used with the fasteners 264, 280.

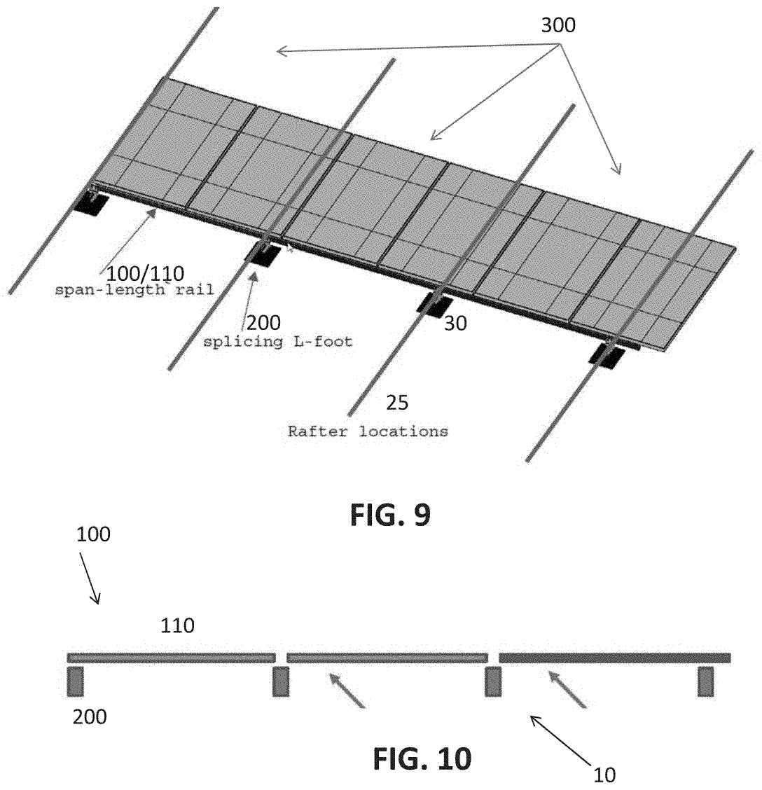

FIGS. 9-10 illustrate the SPARM 10 when utilizing the L-foot connector 200 of FIGS. 7-8. As shown, the short rails 100 have a span length 110 and are connected to the L-foot connectors 200 at the rafter locations 25. PV modules 300 can be mounted on the rails 100.

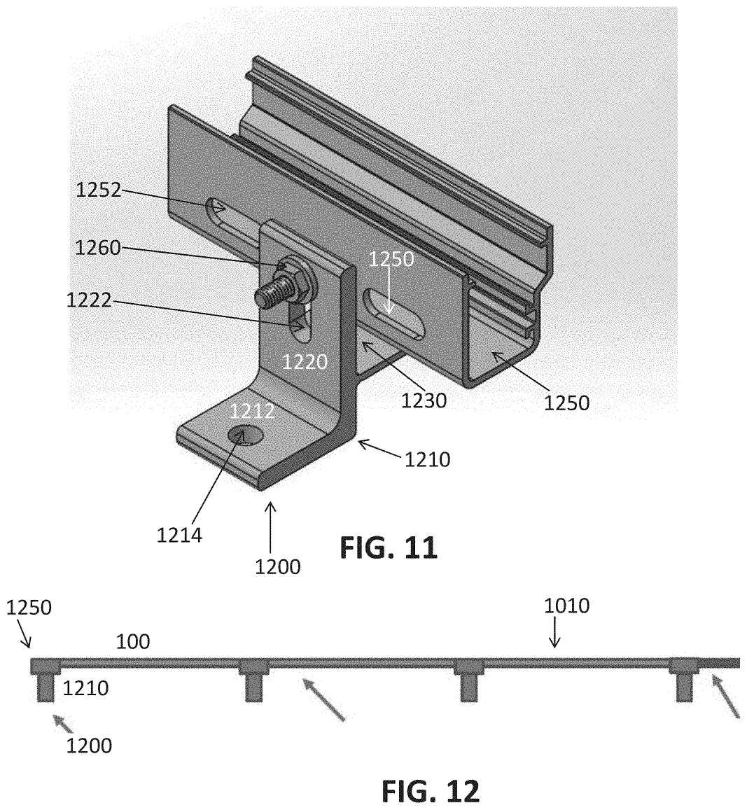

FIG. 11 illustrates a structural splice L-foot connector 1200 according to an aspect of the present invention. In an aspect, the structural splice L-foot connector 1200 comprises an L-foot mount 1210 and a structural splice 1250. A structural splice 1250 is strong and stiff enough so that when it is used to join two sections of rail 1100, the joined rails 1100 have the same or better mechanical characteristics as an un-spliced rail, and roof connections are not increased due to the splice 1250. In an aspect, the L-foot mount 1210 includes a roof portion 1212 with an aperture 1214 configured to receive a fastener (not shown) for mounting the L-foot mount 1210 to the roof. A vertical portion 1220 can extend from the roof portion 1212. The vertical portion 1220 can include an aperture 1222 configured to adjustably receive a fastener 1260 to secure the structural splice 1250 (e.g., aperture has a length that allows height to be adjusted). A support member 1230 can extend from the vertical portion 1220. The support member 1230 is configured to provide support for the structural splice 1250. The structural splice 1250 can include apertures 1252 (two shown, but can include three) configured to secure the structural splice 1250 to the L-foot mount 1210 (i.e., through the aperture 1222 of the vertical portion 1220) with a fastener 1260 and fasteners (not shown) to secure ends of short rails 1100 to the structural splice 1250. In an aspect, the structural L-foot connectors 1200 can be used in locations that do not coincide with rafters 25 on the roof. Such structure L-foot connectors 1200 can be used when the PV module extends beyond the end of a short rail 1100, so additional cantilevered rail is needed. FIG. 12 illustrates a SPARM 1010 utilizing the slice L-foot connector 1200 as discussed above.

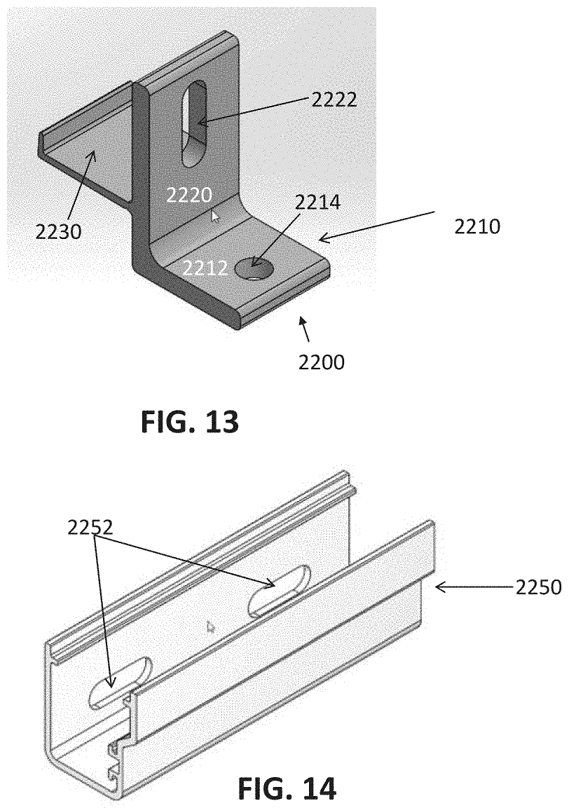

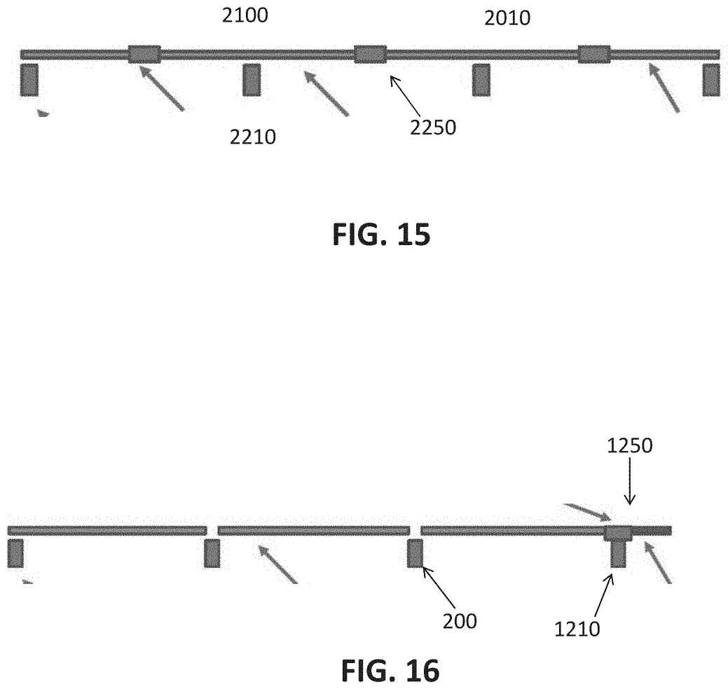

FIGS. 13-15 illustrate a structural splice L-foot connector 2200 having an L-foot component 2210 and a structural splice 2250 that are configured not to be used with one another. In other words, the L-foot component 2210 is configured to engage only with the rails 100 and not the structural splice 2250. In an aspect, the L-foot component 2210 and the structural splice 2250 have similar elements as the L-foot component 1210 and the structural splice 1250 of the structural splice L-foot connector 1100 discussed above. That is, the L-foot component 1210 has a roof portion 2212 with an aperture 2214, a vertical portion 2220 with an aperture 2222 configured to adjustably receive a fastener, and a support member 2230. Further the structural splice 2250 includes apertures 2252. However, in an aspect, the structural splice 2250 is configured to be connected only to ends of short rails 100, and not the L-foot component 2210. In such cases, the structural splice 2250 can be configured to only have enough apertures 2252 to connect to the rails 100, and not the L-foot component (i.e., having two apertures v. three apertures). FIG. 15 illustrates a SPARM 2010 utilizing the separate structural splice 2250 and L-foot component 2110.

In an aspect, a SPARM can utilize a combination of the L-foot connectors 200, 1200, 2200 discussed above. For example, FIG. 16 illustrates a SPARM utilizing the L-foot connector 200 of FIGS. 7-8 with the L-foot connector 1200 of FIG. 11.

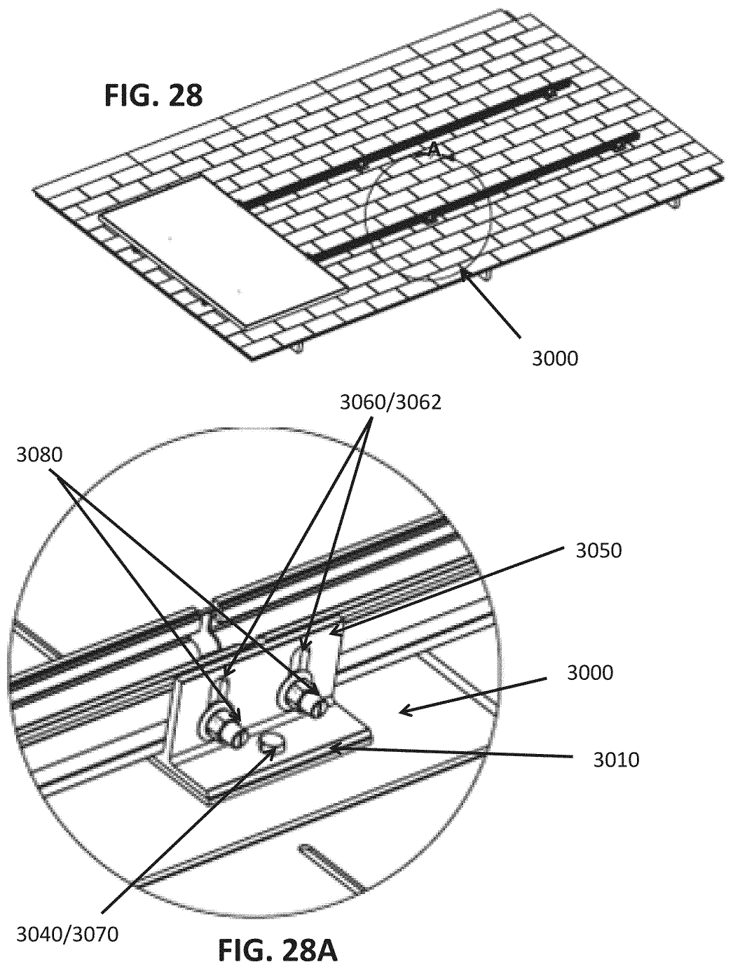

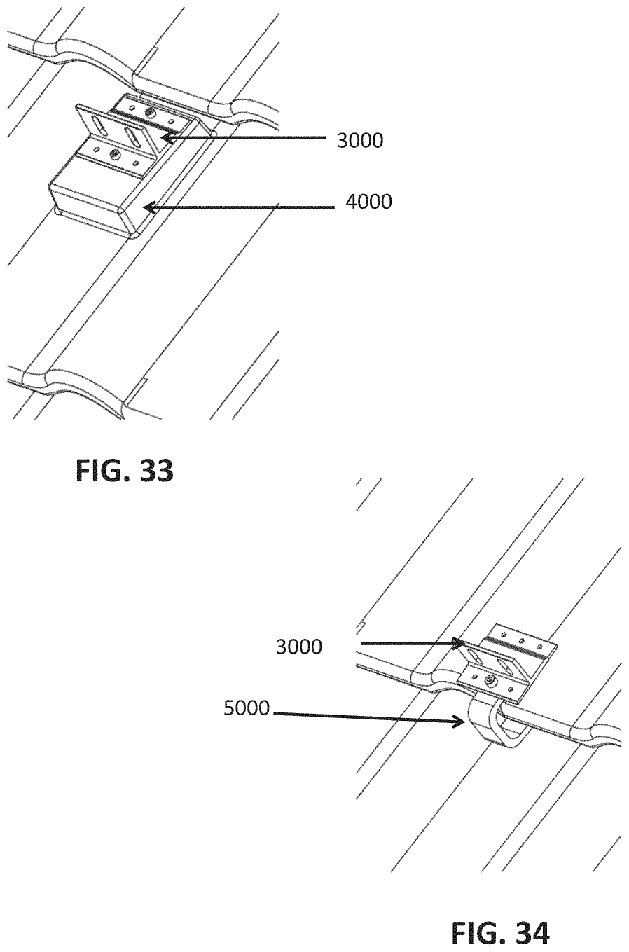

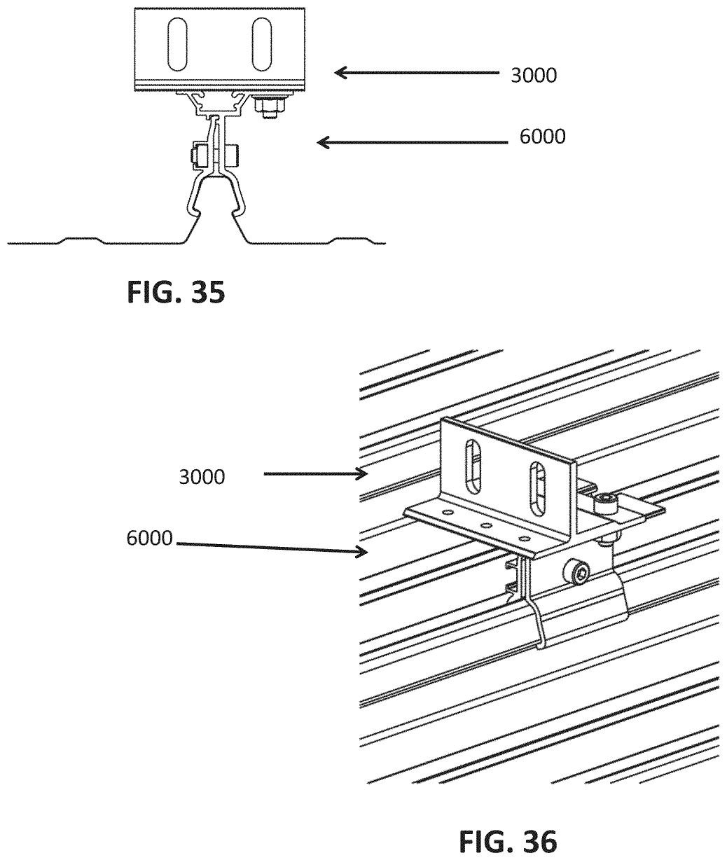

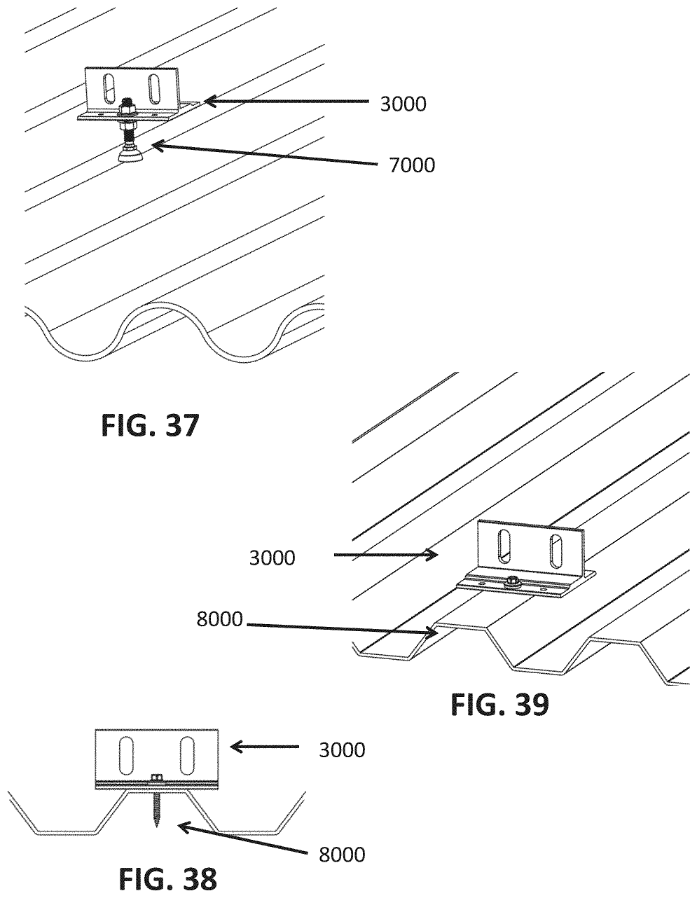

As discussed previously, the L-foot connectors of the present invention can include splice foot connectors. The splice foot mount functions as a roof mount, or part of a roof mount when installed to other roof mounts (e.g., structural tile replacement (FIG. 33), tile hook (FIG. 34), standing seam clamp (FIGS. 35-36) or hanger bolt (FIG. 37)), and a rail connector (FIGS. 28-28A). The splice foot connectors 3000 are used to secure rails, which can be used for solar panel arrays, on a surface. In an aspect, the splice foot connector is configured for a singular rail mount and a dual rail mount (i.e., when two rails are mounted in a continuous line) or when continuing in a certain angle (e.g., two related parallel roof surfaces in an angle to each other, such as in a roof valley). In the dual rail instance, the use of the splice foot connector eliminates the need for a separate splice. These and other features are discussed below.

The splice foot mount 3000 is used on various roofs and structures. For example, the splice foot mount 3000 can be mounted on various roof types, including, but not limited to, slanted, flat, and the like. Similarly, the splice foot mount 3000 can be utilized with various roof coverings, including, but not limited to, composition shingles, tiles, slate, tar paper, saturated felt paper, and the like. In addition, the splice foot mount can be mounted to structural components, including, but not limited to, a roof substrate, any bitumen or asphalt-based roof substrate, any synthetic roof substrate surface (e.g., roof membranes made from polymeric or elastomeric materials), sheet metal surfaces such a various mounted to a surface, including, but not limited to, a roof, substrate, a structural component on a roof, or some other structural component. Along the same lines, the splice foot mount is configured to be mounted to roofs with various coverings, including composition shingles, tiles, standing seam roofs, trapezoidal or corrugated sheet metal, or natural or artificial slate.

In some embodiments, the splice foot mount is configured to be attached on top of other structural components attached to the roof surface or to the roof structure. Such structural components include, but are not limited to, tile hooks, structural tile replacements, hanger bolts, clamps for standing seams, or the like. A butyl pad can be placed between the roof mount component of the splice foot connector and the mounting surface. A gasket or any rubber or similar sealant can be placed between the roof mount surface and any other structural component.

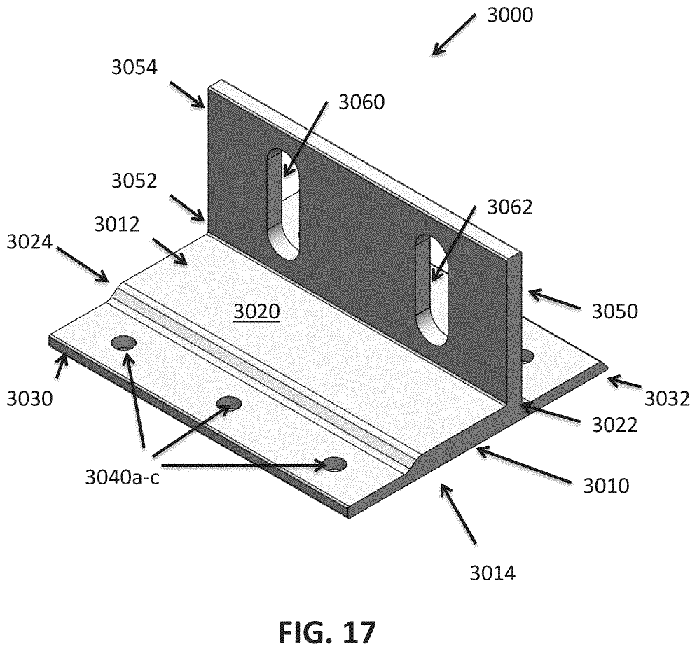

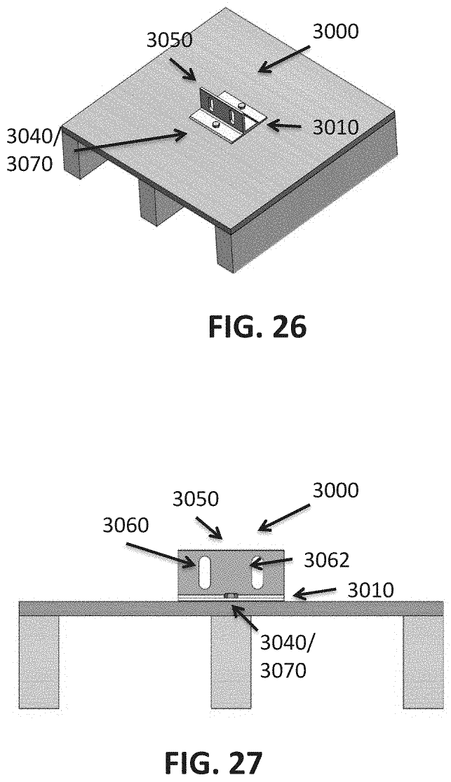

As discussed above, the splice foot connector 3000, as shown in FIGS. 17-39, includes two main components—a roof mount component 3010 and a rail mount component 3050. In an aspect, the roof mount component 3010 extends in a substantially horizontal plane and the rail mount component 3050 extends in a substantially vertical plane from the roof mount component 3010. In an aspect, the rail mount component 3050 intersects the roof mount component 3010 to form a substantially ninety-degree angle with one another.

The roof mount component 3010 includes a top surface 3012 and a bottom surface 3014. In an aspect, the roof mount component 3010 includes a base member 3020 with edges 3022, 3024 and flange members 3030, 3032 that extend outward from the edges 3022, 3024 of the base member 3020. In such aspects, the flange members 3030, 3032 extend in equal lengths from the base member 3020 to provide rigidity and higher resistance against uplift forces. In an aspect, the base member 3020 is thicker than the flange members 3030, 3032 to provide rigidity and higher resistance against shear forces along the roof slope.

The flange members 3030, 3032 include apertures 3040. The apertures 3040 are configured to receive roof fastening devices 3070 to allow mounting to a roof or other structure. In an aspect, the apertures 3040 are substantially circular, and are sized to receive a roof fastening device 3070 with minimum clearance distance in order to ensure a secure mounting.

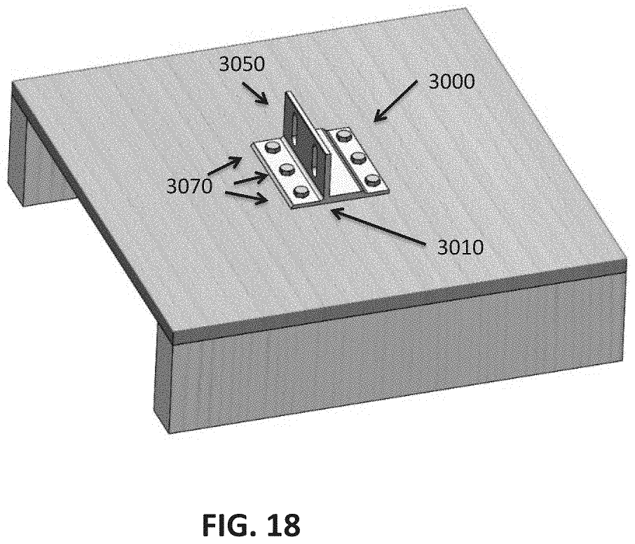

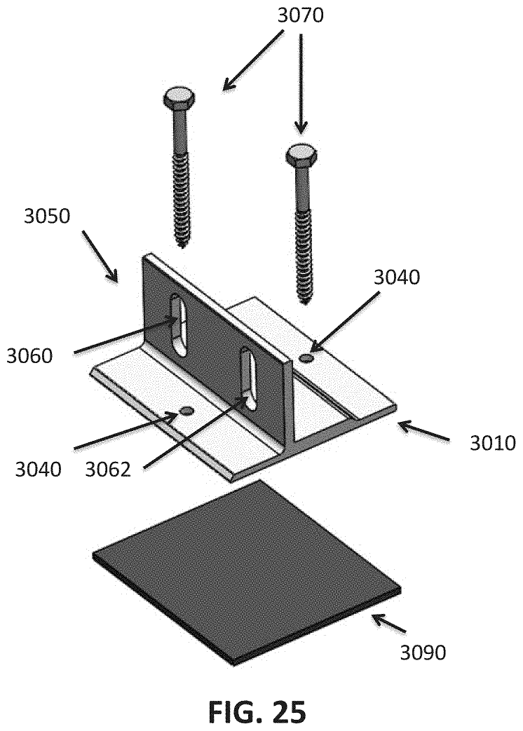

In an aspect, when the splice foot connector 3000 is mounted to a composition shingle roof (see FIGS. 18-27), or other structure with a substrate, the fastening devices 3070 can include lag screws. In some instances of this aspect, the lag screws 3070 utilize a washer positioned between the head of the lag screw and the top surface 3012 of the roof mount component 3010 to prevent water intrusion. In other instances, the lag screws 3070 include a built-in multi-component flange that includes metal and rubber portions, and functions the same way as the washer member discussed. In other aspects, a butyl pad 3090 (as shown in FIG. 25) can be placed between the bottom surface 3014 of the roof mount member 3010 and the roof/support structure to prevent water intrusion when the splice foot connector 3000 is mounted. The primary purpose of the butyl pad is to prevent water intrusion. In some aspects, the mount is also big enough to cover a pilot hole that misses its intended mark (e.g., rafter).

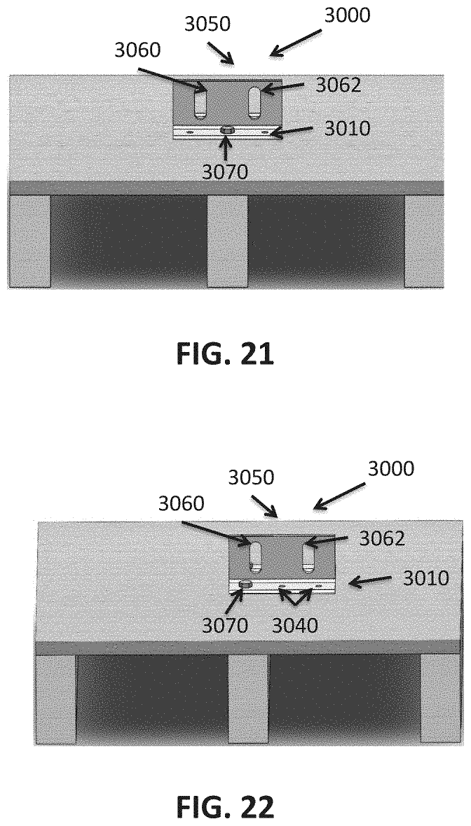

In an aspect, the splice foot connector 3000 can include a single aperture 3040 on each flange member 3030, 3032, as shown in FIGS. 25-27. Such splice foot connectors 3000 are utilized when it is possible to attach the splice foot connector 3000 to a rafter or other structural member of the roof structure. In other aspects, the flange members 3030, 3032 can include three apertures 3040, as shown in FIGS. 17-24. The apertures 3040 can receive various fasteners, including, but not limited to, lag screws, bolts, tapping screws, and the like. Such an arrangement of three apertures 3040 allows the splice foot connector 3000 to be mounted to roof structures at various locations, based upon the length of the rails. In other words, the three aperture 3040 configuration as shown in FIGS. 17-24 allows for the splice foot connector 3000 to be attached at a rafter of a roof in three different arrangements—at an outside aperture 3040 (see FIG. 22), the middle aperture 3040 (FIG. 21), and at the other outside aperture 3040 (similar to FIG. 21, but opposite aperture 3040). Further, the three aperture 3040 arrangement of the splice foot connector 3000 allows for mounting on roofs between rafters, as shown in FIGS. 18-20. By having six total apertures 3040, and hence six fasteners, the splice foot connector 3000 is able to be securely attached. Multiple apertures 3040 on each flange member 3020, 3022 allow for various arrangements of the splice foot connector 3000 on a roof, allowing for adjustable mounting of rails.

As discussed above, the rail mount component 3050 of the splice foot connector 3000 extends vertically upward from the top surface 3012 of the roof mount component 3010, as shown in FIGS. 17-39. The rail mount component 3050 includes a bottom edge 3052 and a top edge 3054, with the bottom edge 3052 connected to the roof mount component 3010. In an exemplary aspect, the bottom edge 3052 is integrally formed (e.g., extrusion forming) with the roof mount component 3010. While the rail mount component 3050 can be attached/connected to the roof mount component 3010 through various means, including adhesives and welding, an integrated formation provides some structural integrity. In such aspects, the rail mount component 3050 extends upwardly from the base member 3020 of the roof mount component. In some instances of these aspects, the rail mount component 3050 can extend upwardly from one of the edges 3022, 3024 of the base member 3020, which applies uplift loads from the rail symmetrically to the two rows of fasteners in the base member 3020. In other instances, the rail mount component 3050 extends from the middle of the base member 3020.

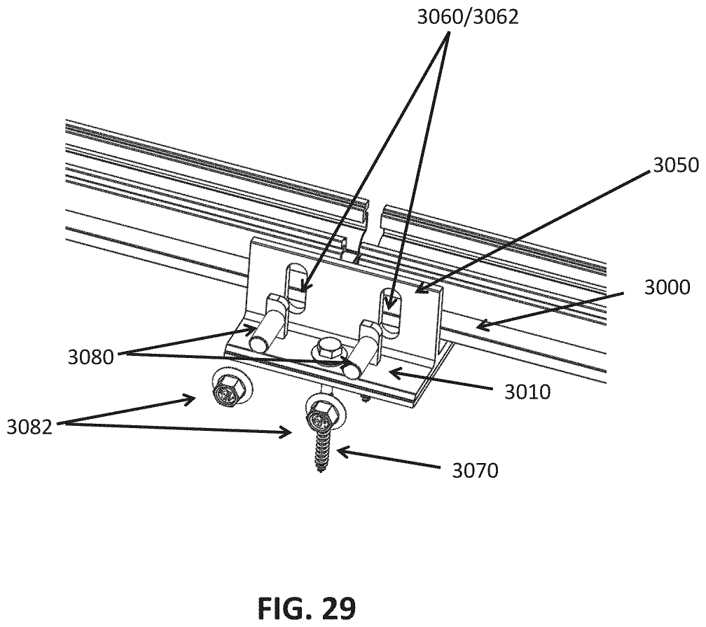

In an aspect, the rail mount component 3050 includes two apertures 3060, 3062 configured to receive rail securing fasteners 3080, as shown in FIGS. 28A and 29. By having two apertures 3060, 3062, the splice foot connector 3000 can be utilized as a mount for a single rail or as a mount for two rails, as shown in FIG. 28. In an aspect, the apertures 3060, 3062 are oriented in a substantially parallel fashion with one another. In an aspect, the apertures 3060, 3062 are spaced apart from one enough so that in a dual rail implementation, the apertures 3060, 3062 allow the connection of two rail ends at the splice foot connector 3000 without overlap of the rails. In an aspect, the apertures 3060, 3062 are elongated, allowing for adjustment of the rail securing fasteners 3070 in a vertical direction within the apertures 3060, 3062. By providing elongated apertures 3060, 3062, the height of the rail when mounted can be adjustable. Once the correct height is reached, the rail securing fasteners 3080 can be tightened to hold the rail in place, as shown in FIGS. 28 and 28A.

The securing rail fasteners 3080 can take various forms and are highly dependent on the rail. For example, in rails having channels (see FIG. 28), t-bolt fasteners 3080, with nuts 3082, can be utilized. In rails that have apertures, a nut and bolt fastener can be utilized. In aspects in which rails do not have channels or apertures, tapping screws can be used to go through the wall of the rail.

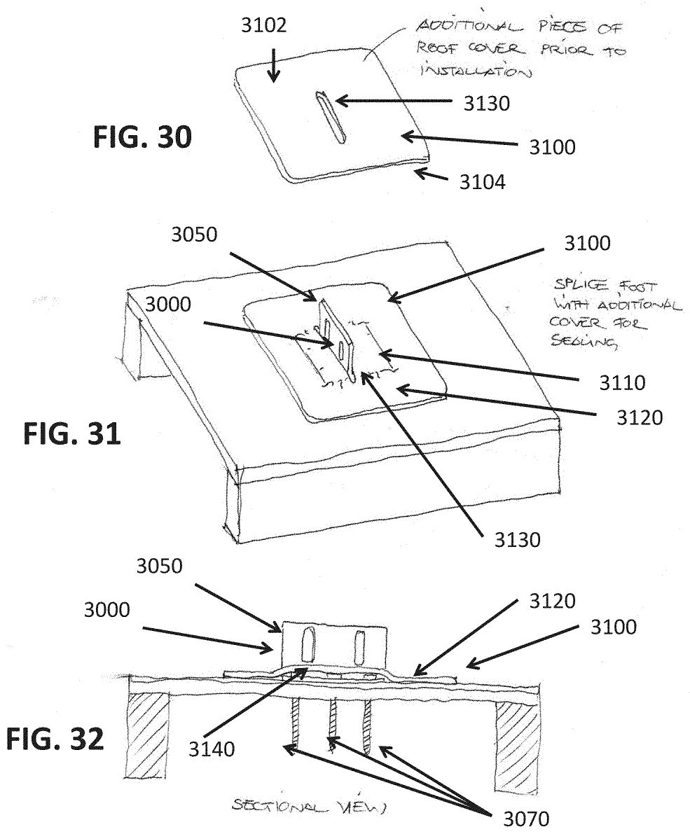

In an aspect, the splice foot connector 3000 can include a cover 3100, as shown in FIGS. 30-32. The cover 3100 can be configured to fit over the splice foot connector 3000. In such aspects, the cover 3100 includes a top surface 3102, a bottom surface 3104, a raised middle portion 3110, a flange portion 3120, and a slit 3130. The slit 3130 is shaped to substantially match the shape of the rail mount component 3050 so the cover 3100 can be slid over the rail mount component 3050 of the splice foot connector 3000.

In an aspect, the dimensions of the raised middle portion 3120 of the cover 3100 substantially match those of the roof mounting component 3010 of the splice foot connector 3000. The arrangement of the raised middle portion 3120 and the flange portion 3130 creates a pocket 3140 on the bottom surface 3104 of the cover 3100 to allow space to receive the roof mounting component 3010 and the fasteners 3070 used to secure the splice foot connector 3000 to the support structure/roof. The cover 3100 can be adhered (e.g., self-adhesive) or welded. In some aspects, the cover 3100 is flexible and therefor can be formed over the raised middle section. Further, the cover 3100 will be a piece of the original roof cover and attached to the roof the same way the pieces of roof covering are attached to each other in most cases welded.

As discussed above, the splice foot connector 3000 can be mounted on a variety of different roof types and support structures. FIG. 33 illustrates the slice foot connector 3000 mounted on a tile replacement 4000, as shown in the art. As shown, the splice foot connector 3000 is connected via fasteners 3070 through apertures 3040 on the roof mount component 3010. In such aspects, one aperture 3040b on each flange member 3030, 3032 is secured via the fasteners 3070, which are received in corresponding apertures (not shown) in the tile replacement 4000.

The splice foot connector 3000 can also be used on tile roofs without a replacement, but using a tile hook 5000, as shown in FIG. 34. As shown, a fastener 3070 can be inserted into an aperture 3040 of the roof mount component 3010 to secure the splice foot connector 3000 to the tile hook 5000.

The splice foot connector 3000 can also be mounted on standing seam roofs, as shown in FIGS. 35-36. In such aspects, the splice foot connector 3000, via the roof mount component 3010, is mounted to a standing seam clamp 6000 via fasteners into apertures or into a channel in the top flange of the clamp. Similarly, the splice foot connector 3000 can be mounted to a corrugated fiber cement surface through the use of a hanger bolt/solar fastener 7000, as shown in FIG. 37. In addition, the splice foot connector 3000 can be mounted to a trapezoidal structural skin/sheet metal 8000 in a similar manner used to a composition shingle roof. In this case, self-tapping screws, thread forming screws, or thin sheet screws are used as fasteners, as shown in FIGS. 38-39.

The splice foot connector does not require metal flashing for it to function (though this is an optional product we will offer). The splice foot connector eliminates the need to pry up shingles and risk damaging them. Further, the splice foot connector prevents the need to pry up roof nails to install a metal flashing. Further, the splice foot connector eliminates the need for a traditional rail connector, as the splice foot connector connects rails. The splice foot connector can be use with the deck attached option (see FIGS. 18-20) to deal with “abnormal” rafter spacing. Sometimes on hipped roofs the rafter will switch from vertical orientation to horizontal. The deck-attached capabilities allow you to install without needing to go into the attic and install an additional support member. On sheet metal roofs the splice foot can be attached to the roof surface directly by screws to the sheet metal surface if the sheet metal is regarded as a structural skin. Or the splice foot is attached to the structure underneath the sheet metal skin e.g., by a hanger bolt.

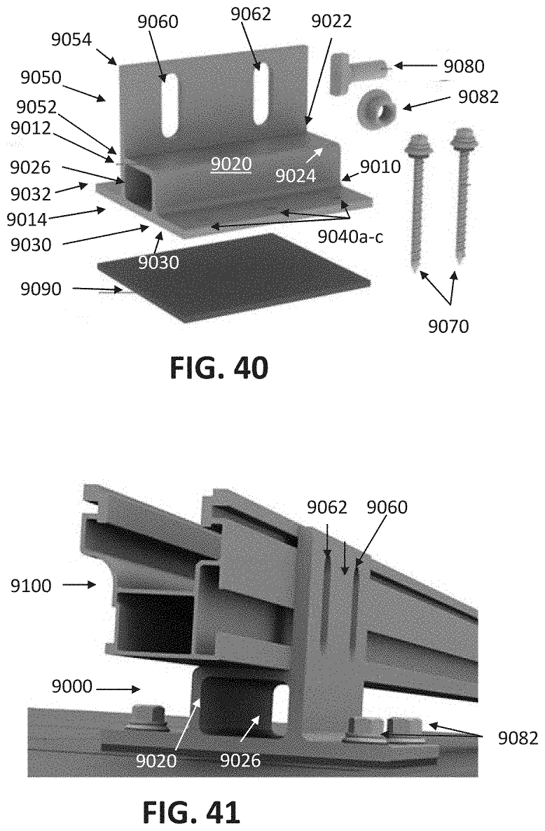

In an aspect, the splice foot connector 9000 may be constructed for larger solar mounts, as depicted in FIGS. 40-41 and 42A-B. The splice foot connectors 9000 are used to secure rails, which can be used for solar panel arrays, on a surface. In an aspect, the splice foot connector is configured for a singular rail mount and a dual rail mount (i.e., when two rails are mounted in a continuous line) or when continuing in a certain angle (e.g., two related parallel roof surfaces in an angle to each other, such as in a roof valley). In the dual rail instance, the use of the splice foot connector eliminates the need for a separate splice. These and other features are discussed below.

As discussed above, the splice foot XL connector 9000 includes two main components—a roof mount component 9010 and a rail mount component 9050. In an aspect, the roof mount component 9010 extends in a substantially horizontal plane and the rail mount component 9050 extends in a substantially vertical plane from the roof mount component 9010. In an aspect, the rail mount component 9050 intersects the roof mount component 9010 to form a substantially ninety-degree angle with one another.

The roof mount component 9010 includes a top surface 9012 and a bottom surface 9014. In an aspect, the roof mount component 9010 includes a raised base member 9020 with edges 9022, 9024 and flange members 9030, 9032 that extend outward from the edges 9022, 9024 of the base member 9020. In such aspects, the flange members 9030, 9032 extend in equal lengths from the base member 9020 to provide rigidity and higher resistance against uplift forces. The raised base member 9020 functions as a horizontal support for rails 9100, similar to the support 2230 of the structural splice L-foot connector 2200, as shown in FIG. 13. In such aspects, the raised base member 9020 is configured to form a hollow interior/channel 9026 running the length of the roof mount component 9010. In such an aspect, the hollow interior 9026 provides strength and rigidity to the roof mount component 9010 in an economic way by adding less material, and therefore less weight. In an aspect, the base member 9020 is thicker than the flange members 9030, 9032 to provide rigidity and higher resistance against shear forces along the roof slope. The flange members 9030, 9032 include apertures 9040. The apertures 9040 are configured to receive roof fastening devices 9070 to allow mounting to a roof or other structure. In an aspect, the apertures 9040 are substantially circular, and are sized to receive a roof fastening device 9070 with minimum clearance distance in order to ensure a secure mounting.

In some embodiments, the splice foot mount is configured to be attached on top of other structural components attached to the roof surface or to the roof structure. Such structural components include, but are not limited to, tile hooks, structural tile replacements, hanger bolts, clamps for standing seams, or the like. A butyl pad 9090 can be placed between the roof mount component 9010 of the splice foot connector 9000 and the mounting surface, as shown in FIG. 40. A gasket or any rubber or similar sealant can be placed between the roof mount surface and any other structural component.

In an aspect, when the splice foot XL connector 9000 is mounted to a composition shingle roof (see FIGS. 40-41), or other structure with a substrate, the fastening devices 9070 can include lag screws. In some instances of this aspect, the lag screws 9070 utilize a washer positioned between the head of the lag screw and the top surface 9012 of the roof mount component 9010 to prevent water intrusion. In other instances, the lag screws 9070 include a built-in multi-component flange that includes metal and rubber portions, and functions the same way as the washer member discussed. In other aspects, a butyl pad 9090 (as shown in FIG. 40) can be placed between the bottom surface 9014 of the roof mount member 9010 and the roof/support structure to prevent water intrusion when the splice foot connector 9000 is mounted. The primary purpose of the butyl pad is to prevent water intrusion. In some aspects, the mount is also big enough to cover a pilot hole that misses its intended mark (e.g., rafter).

In an aspect, the splice foot XL connector 9000 can include one, two, or three aperture(s) 9040 on each flange member 9030, 9032, as shown in FIGS. 40-41. Such splice foot XL connectors 9000 are utilized when it is possible to attach the splice foot connector 9000 to a rafter or other structural member of the roof structure. In other aspects, the flange members 9030, 9032 can include three apertures 9040(a-c), as shown in FIG. 40. The apertures 9040 can receive various fasteners, including, but not limited to, lag screws, bolts, tapping screws, and the like. Such an arrangement of three apertures 9040 allows the splice foot XL connector 9000 to be mounted to roof structures at various locations, based upon the length of the rails. In other words, the three aperture 9040 configuration as shown in FIG. 40 allows for the splice foot XL connector 9000 to be attached at a rafter of a roof in three different arrangements—at an outside aperture 9040 (a or c), the middle aperture 9040(b), and at the other outside aperture 9040(a or c), similar to the mountings discussed above for the splice foot connector 3000 as shown in FIGS. 21-22. Further, the three aperture 9040 arrangement of the splice foot XL connector 9000 allows for mounting on roofs between rafters, similar to the arrangements discussed above for the splice foot connector 300 as shown in FIGS. 18-20. By having six total apertures 9040, and hence six fasteners, the splice foot XL connector 9000 is able to be securely attached. Multiple apertures 9040 on each flange member 9020, 9022 allow for various arrangements of the splice foot connector 9000 on a roof, allowing for adjustable mounting of rails.

As discussed above, the rail mount component 9050 of the splice foot XL connector 9000 extends vertically upward from the top surface 9012 of the roof mount component 9010, as shown in FIGS. 40-42B. The rail mount component 9050 includes a bottom edge 9052 and a top edge 9054, with the bottom edge 9052 connected to the roof mount component 9010. In an exemplary aspect, the bottom edge 9052 is integrally formed (e.g., extrusion forming) with the roof mount component 9010. While the rail mount component 9050 can be attached/connected to the roof mount component 9010 through various means, including adhesives and welding, an integrated formation provides some structural integrity. In such aspects, the rail mount component 9050 extends upwardly from the raised base member 9020 of the roof mount component. In some instances of these aspects, the rail mount component 9050 can extend upwardly from one of the edges 9022, 9024 of the raised base member 9020 (as shown in FIG. 40), which applies uplift loads from the rail symmetrically to the two rows of fasteners in the base member 9020. In other instances, the rail mount component 9050 extends from the middle of the base member 9020.

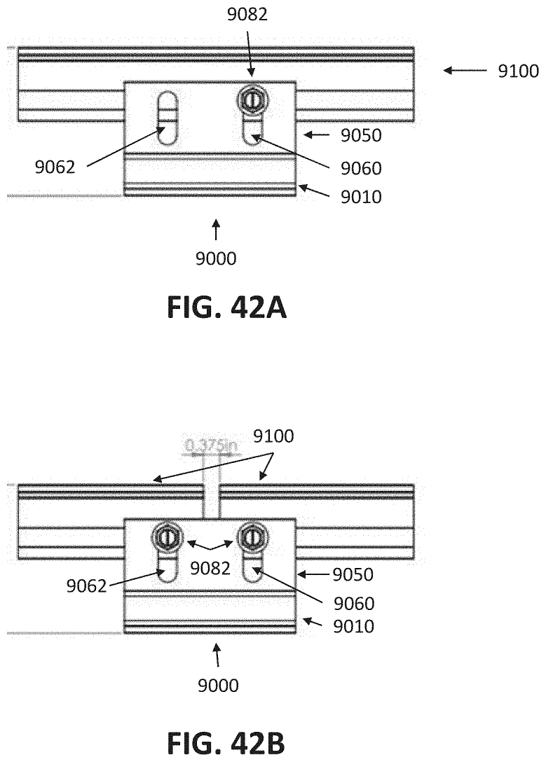

In an aspect, the rail mount component 9050 includes two apertures 9060, 9062 configured to receive rail securing fasteners 9080, as shown in FIGS. 40-41 and 42A-B. By having two apertures 9060, 9062, the splice foot XL connector 9000 can be utilized as a mount for a single rail 9100 or as a mount for two rails 9100, as shown in FIGS. 41-42B. In such aspects, utilizing the splice foot XL connector 9000 to mount a single rail 9100 can additionally be used when the PV module extends beyond the end of a short rail 9100, so additional cantilevered rail is needed. In this aspect the raised base member 9020 acts as a horizontal support similar to the support 2230 of the structural splice L-foot connector 2200, as shown in FIG. 13. In an aspect, the apertures 9060, 9062 are oriented in a substantially parallel fashion with one another. In an aspect, the apertures 9060, 9062 are spaced apart from one enough so that in a dual rail implementation, the apertures 9060, 9062 allow the connection of two rail ends at the splice foot XL connector 9000 without overlap of the rails. In an aspect, the apertures 9060, 9062 are elongated, allowing for adjustment of the rail securing fasteners 9070 in a vertical direction within the apertures 9060, 9062. By providing elongated apertures 9060, 9062, the height of the rail when mounted can be adjustable. Once the correct height is reached, the rail securing fasteners 9080 can be tightened to hold the rail in place, as shown in FIGS. 42A-42B.

The securing rail fasteners 9080 can take various forms and are highly dependent on the rail. For example, in rails having channels (see FIGS. 40-41 and 42A-B), t-bolt fasteners 9080, with nuts 9082, can be utilized. In rails that have apertures, a nut and bolt fastener can be utilized. In aspects in which rails do not have channels or apertures, tapping screws can be used to go through the wall of the rail.

Having thus described exemplary embodiments of the present invention, it should be noted by those skilled in the art that the disclosures are exemplary only and that various other alternatives, adaptations, and modifications may be made within the scope of the present invention. Accordingly, the present invention is not limited to the specific embodiments as illustrated herein, but is only limited by the following claims.

What is claimed is:

1. A photovoltaic array rail mounting system for use on a roof, the system comprising:
a. at least one rail; and
b. a splice foot connector, wherein the splice foot connector can support one rail or two rails.

2. The photovoltaic array rail mounting system of claim 1, wherein the splice foot connector serves as both a mounting bracket and a splice.

3. The photovoltaic array rail mounting system of claim 1, wherein the splice foot connector is configured to receive span-length rails to support a photovoltaic array.

4. The photovoltaic array rail mounting system of claim 1, wherein the splice foot connector comprises a roof mount component and a rail mount component forming a substantially 90-degree angle with one another.

5. The photovoltaic array rail mounting system of claim 4, wherein the rail mount component comprises a plurality of apertures, wherein the plurality of apertures allows connection to one rail or two rails.

6. The photovoltaic array rail mounting system of claim 5, wherein the plurality of apertures comprises elongated apertures to allow for adjustable rail mounting.

7. The photovoltaic array rail mounting system of claim 4, wherein the roof mount component comprises a raised base member to provide horizontal support for the at least one rail.

8. The photovoltaic array rail mounting system of 4, further comprising a cover, wherein the cover is configured to fit over the at least one splice foot connector.

9. The photovoltaic array rail mounting system of claim 4, further comprising a butyl pad, the butyl pad placed between the roof mount component and the roof.

10. The photovoltaic array rail mounting system of claim 1, wherein the splice foot connector is configured to be mounted on a tile replacement.

11. The photovoltaic array rail mounting system of claim 1, further comprising a standing seam clamp used to mount the splice foot connector to a standing seam roof.

12. A method of mounting a photovoltaic ray on a surface comprising:
a. mounting a splice foot connector onto the surface, wherein the splice foot connector is configured to support one or two rails;
b. mounting the one or two rail onto the splice foot connector using one or more fastener(s); and
c. mounting the photovoltaic ray to the one or the two rails.

13. The method of claim 12, wherein the slice foot connector comprises a roof mount component and a rail mount component forming a substantially 90-degree angle with one another, wherein the roof mount component is mounted to the surface and the one or two rails is mounted to the rail mount component, the rail mount component including a first aperture and a second aperture.

14. The method of claim 13, wherein two rails are mounted to the roof mount component by securing a first rail to the first aperture and securing a second rail to the second aperture.

15. The method of claim 13, wherein the roof mount component includes a base member configured to support the one or two rails.
